(19) United States
(12) Patent Application Publication
(10) Pub. No.: US 2015/0315090 A1
(43) Pub. Date: Nov. 5, 2015

(54) LASER GLAZING USING HOLLOW OBJECTS FOR SHRINKAGE COMPLIANCE

(71) Applicant: Siemens Energy, Inc., Orlando, FL (US)

(72) Inventors: Gerald J. Bruck, Oviedo, FL (US); Ahmed Kamel, Orlando, FL (US)

(73) Assignee: Siemens Energy, Inc., Orlando, FL (US)

(21) Appl. No.: 14/267,300

(22) Filed: May 1, 2014

(51) Int. Cl. C04B 41/45; C04B 41/00

(52) U.S. Cl. CPC C04B 41/45; C04B 41/0036; C04B 41/009; C04B 41/4545; C04B 41/4588

(57) ABSTRACT

Hollow objects (18) are incorporated into a layer of glazed material (10) formed on a substrate (12). Powdered glaze material (16) and the hollow objects are heated with an energy beam (22) to melt the glaze material without melting the hollow objects because the hollow objects have a relatively higher melting temperature. The hollow objects provide a degree of mechanical compliance that prevents cracking of the layer of glazed material upon its re-solidification. In other embodiments, a pool of molten material (38, 56) is formed on a substrate (32, 52) and hollow spheres (40, 54) are propelled into the molten material immediately behind the moving beam.

### FIELD OF THE INVENTION

This invention relates generally to the field of materials technology, and more specifically to a process for glazing a surface of a material.

### BACKGROUND OF THE INVENTION

Glazing has been used since ancient times for creating smooth and decorative textures on ceramic objects. Green ceramic objects are typically covered with a dry or aqueous glaze mixture before inserting them into a kiln for firing. The glaze mixture may contain a glass forming agent such as silica, a fluxing agent such as sodium, calcium or potassium metal oxide to lower the melting temperature of the silica, and a stiffening agent such as alumina to prevent runoff of the glaze from the part.

More recently, laser energy has been used as a heat source for the glazing of ceramic thermal barrier coating materials over superalloy gas turbine engine components to protect the coatings from oxidation, corrosion and infiltration of contaminants. However, the extreme local thermal transients generated during laser melting can cause cracking of the glazed surface. U.S. Pat. No. 5,576,069 describes a two-step process to heal such cracking involving the application of a thin layer of zirconia powder followed by a secondary laser remelting step while the substrate is preheated in order to minimize thermal gradients.

### BRIEF DESCRIPTION OF THE DRAWINGS

The invention is explained in the following description in view of the drawings that show:

FIG. 1 illustrates a glazing process utilizing a glazing material incorporating hollow objects.

FIG. 2 illustrates a glazing process wherein hollow objects are introduced into melted substrate material.

FIG. 3 illustrates a glazing process utilizing a glazing material with post-melt introduction of hollow objects.

### DETAILED DESCRIPTION OF THE INVENTION

The present inventors have found the prior art solution to the problem of laser glazing cracking to be unsatisfactory because such two-step processes and special heat treatments add time and expense. Accordingly the inventors have developed an innovative glazing process and glazed product that overcome the problem of cracking of a glazed surface. Instead of repairing cracks and limiting thermal transients during the repair, as is currently done in the art, the present inventors avoid the generation of the cracks in the first place. This is accomplished not by limiting thermal stresses with special heat treatment, but by accommodating the thermal stresses that do occur. This is accomplished by introducing small hollow objects into the glaze melt. The hollow objects provide a degree of mechanical compliance to accommodate shrinkage stresses during solidification of the glaze, thereby preventing cracking.

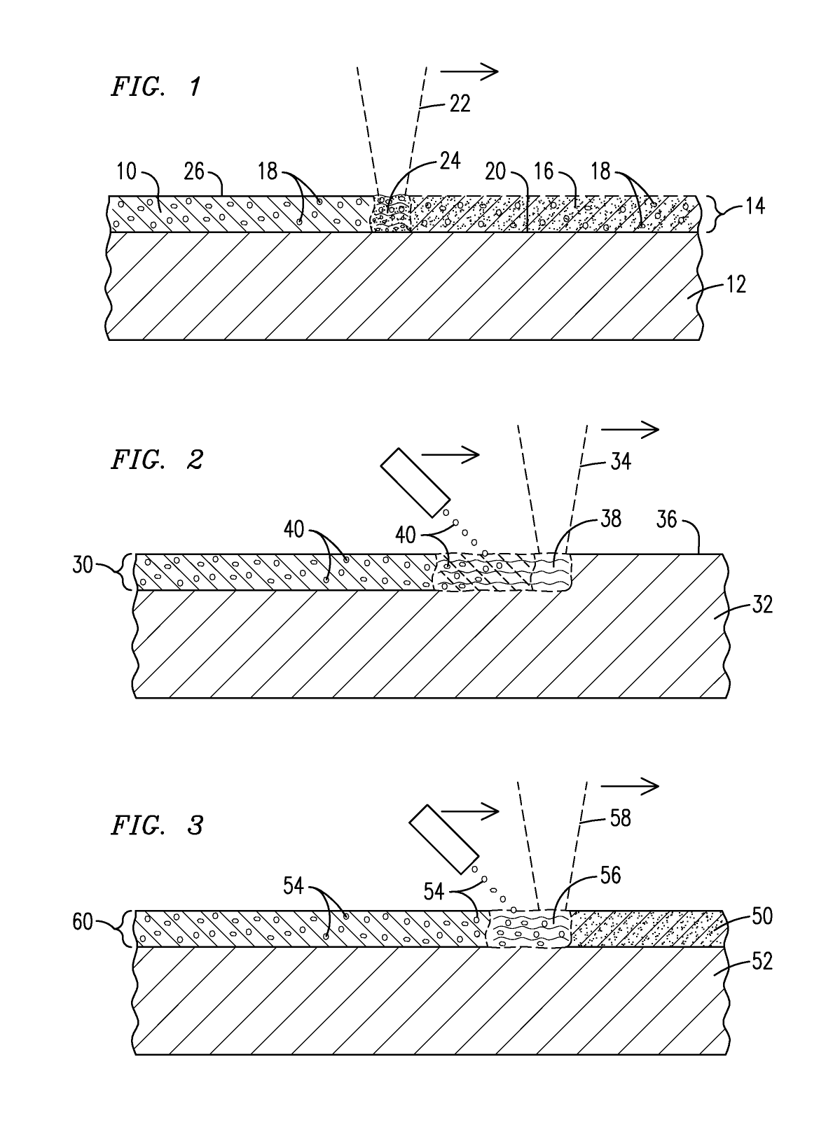

FIG. 1 illustrates an embodiment of the invention where a layer of glazed material 10 is deposited onto a substrate 12. The substrate 12 may be any material that benefits from receiving a glaze, and may include metallic alloys, ceramic materials, and ceramic matrix composite materials such as are used for hot gas path components in gas turbine engines. In FIG. 1, substrate 12 may be a ceramic thermal barrier coating material deposited on a superalloy gas turbine engine component. The layer of glazed material 10 in this embodiment is formed by melting and re-solidifying a layer 14 of material including powdered glaze material 16 and hollow objects 18 that has been placed onto a surface 20 of the substrate 12. The powdered glaze material 16 may include glass forming, fluxing and stiffening constituents as desired for a particular application. An energy beam, such as an ion beam or a laser beam 22, is traversed across the surface 20 to form a pool of molten material 24 that progresses across the surface 20 as indicated by the direction of the arrow in the figure.

Advantageously, the hollow objects 18 are not melted by the beam 22, such as by being formed of a material having a higher melting temperature than that of the powdered glaze material 16. The molten material is allowed to solidify around the hollow objects 18 behind the beam 22 to create the glazed surface 26. Flexing of the hollow objects 18 during the solidification process accommodates shrinkage stresses, thereby preventing cracking. Incidental melting of some portion of the surface of the hollow objects 18 is included in the condition of “not melted” described herein, as long as the objects 18 retain their geometric form of being hollow in order to provide the degree of mechanical compliance described.

The hollow objects 18 may be nano, micro or milli sized, with smaller objects typically being used for thinner glazed layers 10. In one embodiment, the hollow objects 18 may be hollow silica spheres from 1.5-5 microns in diameter which are commercially available from Microspheres-Nanospheres, a Corpuscular company (http://microspheres-nanospheres.com). Other oxide materials may be used to form the hollow objects 18, such as SiO₂, TiO₂, Al₂O₃, or ZrO₂, for example. Hollow shapes other than spheres may be used, such as cubic silica particles that have been developed for use in lithium ion battery construction.

FIG. 2 illustrates an embodiment of the invention where a layer of glazed material 30 is formed on a substrate 32. In this embodiment, no powdered glazing material is used, but rather, an energy beam 34 is traversed across the surface 36 of the substrate 32 to form a pool of molten substrate material 38 moving in the direction of the arrow in the figure. Immediately behind the energy beam 34, and in a region where the molten substrate material 38 has not yet solidified, a plurality of hollow objects 40 are propelled into the pool of molten substrate material 38. The molten material 38 then solidifies around the hollow objects 40 to form the compliant layer of glazed material 30. In this embodiment, the hollow objects 40 are not exposed directly to the heat of the energy beam 34, and therefore it is possible, although not mandatory, to form the hollow objects 40 of materials having lower melting temperatures than may be operable for the embodiment of FIG. 1. In one embodiment, the hollow objects 40 are formed of the same material as the substrate 32, and while they may experience some incidental surface melting upon being introduced into the pool of molten substrate material 38, they act as a local heat sink causing solidification of the molten material without melting of the objects 40. In this manner, porosity and mechanical compliance can be introduced into the layer of glazed material 30 without changing its chemical composition. In another embodiment, the hollow spheres 40 are formed of carbon which sublimes at a very high temperature (about 3,642° C.), which facilitates their introduction into a molten superalloy or MCrAlY substrate material 38.

FIG. 3 illustrates another embodiment wherein a powdered glaze material 50 is deposited onto a substrate 52 without the inclusion of hollow objects, and the hollow objects 54 are introduced into the pool of molten material 56 directly behind the moving energy beam 58, whereupon they are incorporated into the layer of glaze material 60 upon solidification.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
directing an energy beam to create a layer of molten material on a substrate;
including a plurality of hollow objects within the layer of molten material; and
allowing the molten material to solidify around the hollow objects to create a glazed surface.

2. The method of claim 1, further comprising:
depositing a layer comprising powdered material and the hollow objects onto a surface of the substrate; and
directing the energy beam to melt the powdered material without melting the hollow objects to create the layer of molten material.

3. The method of claim 1, further comprising introducing the hollow objects into the layer of molten material behind the energy beam as the energy beam traverses the surface.

4. The method of claim 1, further comprising:
directing the energy beam to melt a surface layer of the substrate to create the layer of molten material; and
introducing the hollow objects into the layer of molten material before the molten material solidifies.

5. The method of claim 1, further comprising:
selecting the hollow objects to have a melting temperature higher than a glass forming material;
depositing the glass forming material and the hollow objects onto a surface of the substrate; and
heating the glass forming material and the hollow objects to a temperature above a melting temperature of the glass forming material but below the melting temperature of the hollow objects.

6. The method of claim 1, wherein the substrate comprises either a ceramic material or a metallic alloy and the hollow objects comprise carbon.

7. The method of claim 1, wherein the hollow objects comprise hollow spheres.

8. The method of claim 1, wherein the energy beam comprises a laser beam.

9. The method of claim 1, further comprising:
traversing the energy beam across a surface of the substrate to create a pool of molten substrate material;
propelling hollow objects formed of a same composition as the substrate into the layer of molten substrate material before the molten material solidifies; and
allowing the molten substrate material to solidify around the hollow objects without melting the hollow objects.

10. The method of claim 1, further comprising:
depositing a layer comprising powdered glaze material onto a surface of the substrate;
directing the energy beam to melt the powdered material to create the layer of molten material; and
introducing the hollow objects into the layer of molten material behind the energy beam as the energy beam traverses the surface.

11. A product formed by the process of claim 1 to comprise:
a substrate;
a layer of glazed material disposed on the substrate; and
a plurality of hollow objects disposed in the layer of glazed material.

12. A method comprising:
traversing a laser beam across a selected portion of a surface to create a layer of molten material;
including a plurality of unmelted hollow spheres within the layer of molten material; and
allowing the molten material to solidify around the hollow spheres to form a layer of glazed material.

13. The method of claim 12, further comprising:
depositing a layer comprising powdered glazing material and the hollow spheres onto the surface; and
traversing the laser beam to melt the powdered glazing material without melting the hollow spheres to create the layer of molten material.

14. The method of claim 12, further comprising introducing the hollow spheres into the layer of molten material behind the laser beam as the laser beam traverses the surface.

15. The method of claim 14, wherein the hollow spheres are formed of a same composition as that of the surface.

16. The method of claim 12, further comprising:
traversing the laser beam across a surface of an alloy material to create a layer of molten alloy material; and
including a plurality of hollow carbon spheres within the layer of molten alloy material.

17. The method of claim 12, further comprising:
depositing a glazing material comprising the hollow spheres onto a surface of a thermal barrier coating of a superalloy gas turbine engine component;
traversing the laser beam across a selected portion of the surface of the thermal barrier coating to create a layer of molten glazing material;
allowing the layer of molten glazing material to solidify around the hollow spheres to glaze the surface of the thermal barrier coating material without inducing cracking.

18. A product formed by the process of claim 17.

19. The method of claim 12, further comprising:
depositing a glazing material without hollow spheres onto the surface;
traversing the laser beam across the selected portion of the surface to create a layer of molten glazing material;
introducing the hollow spheres into the layer of molten material behind the laser beam as the laser beam traverses the surface; and
allowing the layer of molten glazing material to solidify around the hollow spheres.
